(19) United States
(12) Patent Application Publication
(10) Pub. No.: US 2003/0053183 A1
(43) Pub. Date: Mar. 20, 2003

(54) Method for capturing images useful in a scanning system

(75) Inventors: Yin-Chun Huang, Hsin-chu (TW); Wen-Chao Tseng, Taichung (TW)

Correspondence Address: LOWE HAUPTMAN GILMAN & BERNER, LLP, Suite 310, 1700 Diagonal Road, Alexandria, VA, 22314, US

(73) Assignee: UMAX DATA SYSTEMS INC.

(21) Appl. No.: 09/956,116

(22) Filed: Sep. 20, 2001

(51) Int. Cl. G02B 26/08

(52) U.S. Cl. 359/196

(57) ABSTRACT

A method for capturing images useful in a scanning system is provided. The present method comprises performing a preview scan of a picture and then displaying the preview image of the picture on a screen. Selecting a scanning area of the preview image and simultaneously performing a first normal scan of the picture from an initial scanning position relative to the picture. When the scanned area of the first normal scan corresponds to the selected scanning area, the scan image produced by the first normal scan is displayed. Otherwise, a second normal scan of a portion of the picture that corresponds to the selected scanning area is performed to produce a final scan image.

### BACKGROUND OF THE INVENTION

1. Field of the Invention

The present invention relates to a method for capturing images, and more particularly to a method for capturing images useful in a scanning system.

2. Description of the Prior Art

A scanner is a device that converts a visible image such as a photograph, transparency or printed paper into an electronic form suitable for copying, storing or processing by a computer.

In the prior art for scanners, a picture is placed on a scanner window. The scanner scans the picture and stores the resultant image in a computer memory. The image may then be displayed upon a monitor. The conventional scanners usually provide a preview function that can quickly scan a picture in low resolution to generate a preview image. A user can then specify one or more scanning areas/target areas on the preview image to instruct the scanner to scan only the designated areas. The scanner will later scan the designated areas in high resolution and transmit only the images from the designated areas back to a computer. In accordance with the operation of the conventional scanners, after the preview image is displayed, a normal scan of a portion of the picture that corresponds to the designated area is then performed. However, the scanner is on standby during this period of time to specify the scanning areas/target areas of the preview image. Thus, it is time-consuming procedure to capture an image of a picture by the conventional scanning system.

Accordingly, it is the intention to provide a method for capturing images useful in a scanning system, which is able to simultaneously perform a normal scan and designation of which portion of a picture to capture.

### SUMMARY OF THE INVENTION

It is one objective of the present invention to provide a method for capturing images useful in a scanning system. In addition, which simultaneously performs a normal scan and designation of a specific portion of a picture for capture in order to save time when specifying the scanning areas/target areas of the preview image, thus facilitating the image capture of the picture.

It is another objective of the present invention to provide a method for capturing images useful in a scanning system, which can automatically scan the whole image of a picture in case that a user does not specify which portion of the picture needed for capture.

It is a further objective of the present invention to provide a method for capturing images useful in a scanning system, which can specify the scanning areas/target areas of a preview image and scan the parameters of a normal scan through a scan window. Therefore, a user can perform the present method conveniently and easily.

In order to achieve the above objectives of this invention, the present invention provides a method for capturing images useful in a scanning system. A preview scan of a picture to produce a preview image of the picture is performed. The preview image of the picture is displayed on a screen. Selecting a scanning area of the preview image that corresponds to a portion of the picture and simultaneously performing a first normal scan of the picture from the initial scanning position relative to the picture. Determining if the scanned area of the first normal scan corresponds to the selected scanning area. When the scanned area corresponds to the selected scanning area, the scan image produced by the first normal scan is displayed. While the scanned area does not correspond to the selected scanning area, a second normal scan of a portion of the picture which corresponds to the selected scanning area is performed to produce a final scan image.

### BRIEF DESCRIPTION OF THE DRAWINGS

The objectives and features of the present invention as well as advantages thereof will become apparent from the following detailed description, considered in conjunction with the accompanying drawings.

FIG. 1 is a block diagram of a scanner system in accordance with one embodiment of the present invention; and

FIG. 2 is a flowchart of a preview can and normal scan process of the scanner system shown in FIG. 1.

### DESCRIPTION OF THE PREFERRED EMBODIMENT

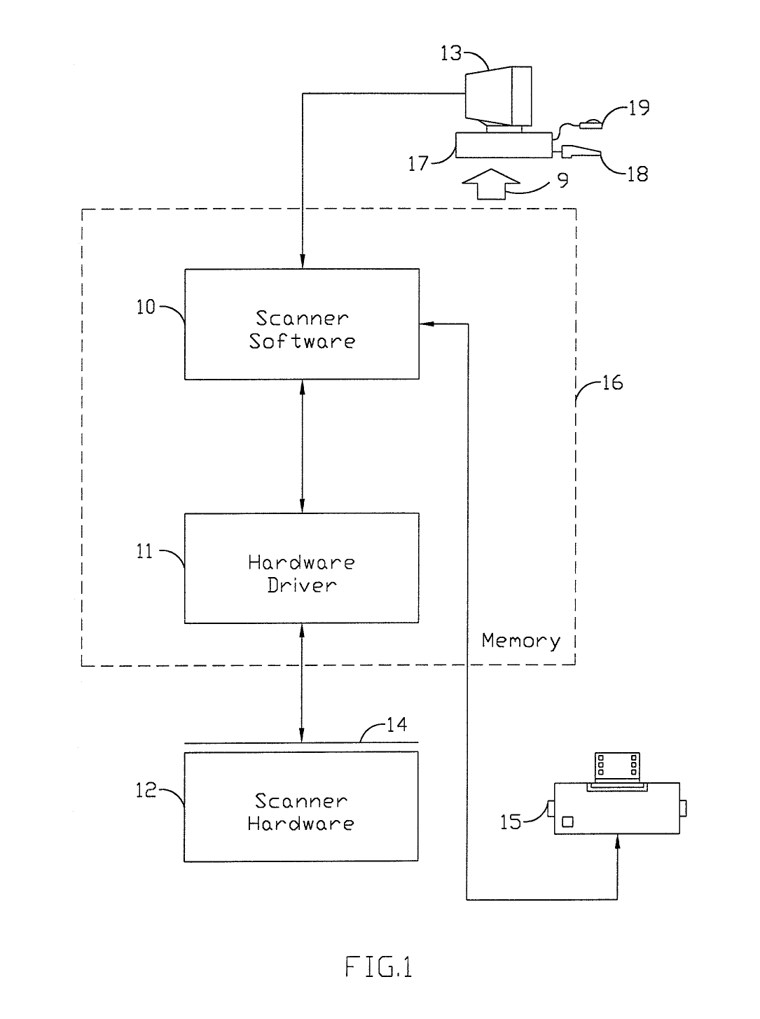

FIG. 1 shows a block diagram of a scanner system, used in the present invention. A computer 17 is shown coupled to monitor 13. A keyboard 18 and a mouse 19 are also coupled to the computer 17.

Scanner software 10 interacts with a hardware driver 11 to cause scanner hardware 12 to scan a picture 14 placed upon scanner hardware 12. Upon successful retrieval of an image of picture 14, a user displays the image upon a monitor 13 for view. The user may then print out the image using a printer 15. Scanner software 10 and hardware driver 11 both reside within a system memory 16. As demonstrated by arrow 9, memory 16 resided in the computer 17.

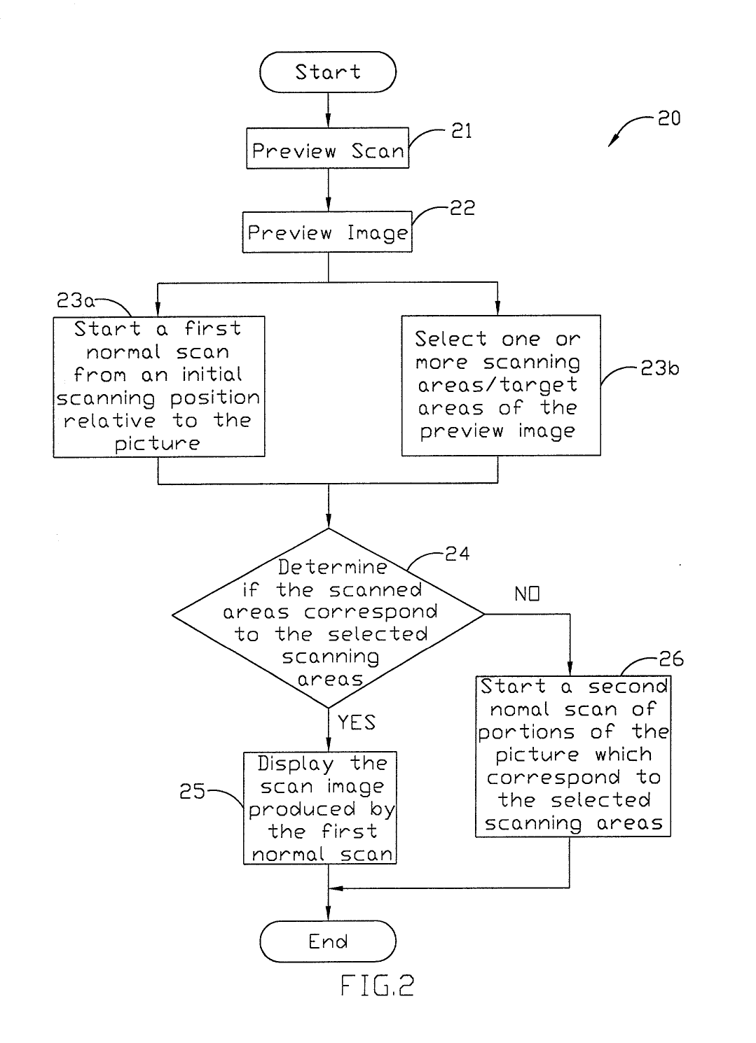

FIG. 2 shows a flowchart 20 of a preview scan and normal scan process in accordance with one embodiment of the present invention. When a user desires to capture an image of a picture 14, he places the picture 14 upon scanner hardware 12. The scanner system shown in FIG. 1 will operate following the flowchart 20 of FIG. 2.

Firstly, in step 2 1, a preview scan of the picture 14 is performed to produce a preview image of the picture 14. Then, in step 22, the preview image of the picture 14 is displayed on a screen, such as monitor 13. Thereafter, step 23a and step 23b are simultaneously performed. In step 23a, a first normal scan of the picture 14 with scan parameters which specify: (1) intensity of the displayed image; (2) resolution of the image; (3) scaling factors, is performed from an initial scanning position relative to the picture 14, for example a home position of the scanner hardware 12. Those scan parameters of the first normal scan are defaults chosen by the scanner software 10. Simultaneously, in step 23b, a user can select one or more scanning areas/target areas of the preview image, which correspond to portions of the picture 14 the user wants to capture, through a scan window. In step 23b, the user can also specify scan parameters such as intensity of the displayed image, resolution of the image and scaling factors etc, by a dialog box under the scan window. Following is step 24. In step 24, determining if the scanned areas of the first normal scan correspond to the selected scanning areas of the preview image. When the scanned areas correspond to the selected scanning areas, step 24 is followed by step 25. In step 25, the scan image produced by the first normal scan is captured and displayed on the screen. While, when the scanned areas do not correspond to the selected scanning areas, step 26 will follow step 24. In step 26, a second normal scan of portions of the picture 14 which correspond to the selected scanning areas of the preview image is performed to obtain a final scan image. The second normal scan is performed with scan parameters set in step 23b.

Alternately, after step 22, if the user does not specify portions of the picture 14 he wants to capture by selecting scanning areas/target areas of the preview image, the first normal scan of the whole picture will be automatically performed to obtain a final scan image. This function can be set in the scanner software 10.

In view of the foregoing, the present invention provides a method for capturing images useful in a scanning system, which saves time for designation of which portion of the picture wanted to capture, thus facilitating the image capture of a picture. The present invention also provides the capability to simultaneously perform a normal scan and designation of portions of a picture a user wants to capture through a scan window. Therefore, the method of the present invention is user-friendly.

The preferred embodiment is only used to illustrate the present invention, it is not intended to limit the scope thereof. Many modifications of the embodiment can be made without departing from the spirit of the present invention.

What is claimed is:

1. A method for capturing images useful in a scanning system, comprising:
performing a preview scan of a picture to produce a preview image of the picture;
displaying said preview image of the picture on a screen;
selecting a scanning area of said preview image which corresponds to a portion of the picture and simultaneously performing a first normal scan of the picture from the initial scanning position relative to the picture;
determining if the scanned area of said first normal scan corresponds to the selected scanning area; and
displaying on the screen the scan image produced by said first normal scan when the scanned area corresponds to the selected scanning area; while if the scanned area does not correspond to the selected scanning area, performing a second normal scan of a portion of the picture which corresponds to the selected scanning area to produce a final scan image.

2. The method of claim 1, wherein the step of selecting a scanning area of said preview image is executed through a scan window.

3. The method of claim 2, wherein the step of selecting a scanning area of said preview image comprises setting scan parameters.

4. The method of claim 3, wherein the scan parameters are set through a dialog box under the scan window.

5. The method of claim 1, wherein said first normal scan is performed with predetermined scan parameters.

6. The method of claim 1, further comprising automatically performing said first normal scan of the whole picture by setting in a scan software when a user does not select a scanning area of said preview image.
